(19) United States
(12) Patent Application Publication
(10) Pub. No.: US 2003/0209345 A1
(43) Pub. Date: Nov. 13, 2003

(54) Tube-in-tube repairable heat exchanger with cross flow

(76) Inventor: Mark Alan Zweig, Gloster, MS (US)

Correspondence Address: MARK ALAN ZWEIG, PO BOX 415, GLOSTER, MS, 39638, US

(21) Appl. No.: 10/430,238

(22) Filed: May 5, 2003

Related U.S. Application Data
(60) Provisional application No. 60/378,609, filed on May 7, 2002.

(51) Int. Cl. F28D 7/10; B23P 6/00

(52) U.S. Cl. 165/154; 29/890.031

(57) ABSTRACT

A heat exchanger with a corrosion resistant, preferably titanium tube (25), housing a medium, usually a refrigerant, surrounded by an outer tube, preferably a flexible PVC see-through spa hose (26), carrying liquid moving in the opposite direction to the refrigerant, to provide a device that is repairable, simple to install or remove, simple to ship, resistant to corrosion, erosion, and UV light damage, to prevent heat exchanger failure in an industry plagued with this problem.

### CROSS REFERENCE TO RELATED APPLICATIONS

This application claims the benefit of PPA Ser. No. 60/378,609

### FEDERALLY SPONSORED RESEARCH

Not Applicable

### SEQUENCE LISTING ON PROGRAM

Not Applicable

### BACKGROUND OF THE INVENTION

1. Field of Invention

The invention relates to a heat exchanger for use in heat transfer applications by transferring heat from one liquid or gas medium to another liquid across a heat transfer tube, specifically to a method and apparatus of efficiently transferring heat between two mediums across a corrosion resistant tube within a repairable device that is easily transportable for diverse applications in its use as an evaporator or condenser, for use in water heaters and coolers, particularly for use with swimming pool water, spa water, geothermal use, aquarium water (salt or fresh), and in marine engines and other heat pumps.

2. Description of Prior Art

Heat exchangers that transfer heat to or from a liquid have diverse applications. They have been made as “compressed plates,” “tube in tube,” “tube in shell,” “tubes in tub,” and “tube in tub” and many other varieties. The tube-in-tube variety is simple and effective because you can reverse the direction of the two mediums gaining the added efficiency of the principle called “cross flow” or “counter flow.”

The heat exchanger in corrosive environments, has plagued many industries, especially the geothermal and pool and spa water heating industries. Industry has used “copper-nickel” combinations and stainless steel for heat transfer, but these metals have been plagued with the problem of corrosion, especially from salt water and even more from the use of salt-chlorine generators in swimming pools.

The industry's use of refrigeration to heat swimming pool water was proposed in U.S. Pat. No. 3,498,338 to Steifel. Since then, the industry has tried all types of heat exchanger modifications such as ceramic coating and powder coating the metal tubes, and trying many different metal compositions. All have been plagued by pitting corrosion that allows water to seep into the refrigeration system, corroding it. Eventually, the industry turned to titanium and 254 SMO, and other corrosion resistant metal alloys. Today, the heat exchangers are almost all turning to using titanium and practically all have a “tube in tub” design. Recently, in U.S. Pat. No. 6,293,335 to Tawney et. al, in an attempt at making a titanium heat exchanger, a tube in tub design was attempted. Coils in a tub tend to vibrate, from the action of the compressor, and can erode leading to failure. Then in U.S. Pat. No. 6,499,534 to Tawney et. al, a revision on the tub is attempted, trying to accomplish cross-flow in the way a tube in tube heat exchanger works This revision is similar to that of U.S. Pat. No. 4,719,969 to Patton et. al. where vibration problems and lack of cross flow were addressed in a design trying to make a tub work like a tube. Several companies from the U.S. and Canada have used copper-nickel combinations as a tube in tube, but all have had countless failures because the copper-nickel gets “eaten” away and eventually fails needing a replacement heat exchanger.

Repair and replacement of heat exchangers have been difficult and costly and mostly cost prohibitive. U.S. Pat. No. 4,559,436 to Roach et. al., describes a way of repairing one of the leaking tubes in a heat exchanger. Also, in U.S. Pat. No. 6,128,822 to Nishio et. al., a compound has been used to try to repair the bulkhead on that type of heat exchanger. In U.S. Pat. No. 4,573,248 to Hackett the insertion of repair sleeves into tubes is used as an option in that heat exchanger. Specifically, in the water-source and geothermal and heat pump industries, repairable heat exchangers have been unavailable.

The industry has definitely moved towards titanium tube and plastic outer chambers as the answer to the corrosion problem, as described in U.S. Pat. No. 5,487,423 to Romero. Although they have contemplated the answer, altering a tub to mimic a tube, they do not reach the full efficiency of a tube in a tube. These inventors, suggest tub alterations to get there, but they are attempting to lower the cost of the product in exchange for loss of efficiency and loss of performance.

### OBJECTS AND ADVANTAGES

Accordingly, besides the objects and advantages of the tube in tube construction that can be called a “tube in hose” construction described in my above patent, several objects and advantages of the present invention are:

(a) to provide a heat exchanger that is finally completely repairable, especially with its clear “see-through” outer hose, that lets you visualize the site of the leak and repair the damaged internal tube, and now the heat exchanger can be reused instead of being thrown away, eliminating the huge loss, and

(b) to provide a heat exchanger that is easily retro-fit into almost any industry product due to its simple design and adaptability, and

(c) to provide a heat exchanger that performs better than current tube in tub designs due to the actual tube in tube design with actual cross flow, and

(d) to provide a heat exchanger that is easier to install or remove compared to other heat exchangers due to lack of hardware needed to bolt it down to equipment, and

(e) to provide a heat exchanger that fits easily in a box that can be overnight shipped to factory for quick repair and quick return, saving the end user the huge expense of replacement of the heat exchanger.

Further objects and advantages are to provide a heat exchanger that will finally add credibility and preserve the reputations of the larger companies entering into the emerging heat pump swimming pool and spa heating industry. Still further objects and advantages will become apparent from a consideration of the ensuing description and drawings.

### SUMMARY

The industry now has the solution to its problems in a highly efficient tube in tube heat exchanger with real cross flow, that is highly corrosion resistant, easily repairable and replaceable, and simple in design.

### DRAWINGS

In the drawings, closely related figures have the same number but different alphabetic suffixes.

FIG. 1 shows a view of the completed heat exchanger with both tubes in a spiral helix

FIG. 2 shows a view from above that shows the hollow center of the helix to leave room for a compressor if used inside of a heat pump air coil

FIG. 3A shows the ending plastic PVC “tee” and FIGS. 3B and 3C show the parts that complete the sealing of the water chamber

FIG. 4 shows a segment of the heat exchanger showing the tube in tube design with the titanium tube within a clear spa hose

FIG. 5A shows the joining of multiple units in series and FIG. 3B shows joining in parallel

### Reference Numerals

| | |
|---|---|
| 21 | PVC “Tee” |
| 22 | Water inlet/outlet |
| 23 | Reducing Bushing |
| 24 | Fitting |
| 25 | Internal Tube |
| 26 | Outer tube |
| | (preferably Titanium) |
| | (preferably flex PVC) |
| 27 | Refrigerant inlet/outlet |
| 28 | Upper Outlet Tee |
| 29 | Lower Inlet Tee |

### DETAILED DESCRIPTION

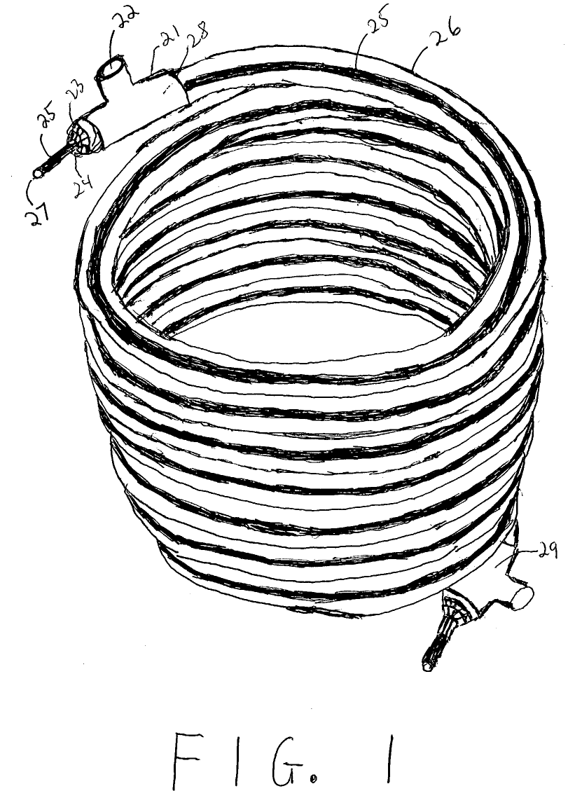

FIG. 1-Preferred Embodiment

A preferred embodiment of the heat exchanger of the present invention is illustrated in FIG. 1, embodying a heat exchanger to form an evaporator or condenser unit for diverse applications, including water heaters and coolers for swimming pools, spas, aquariums, and a heat exchanger for geothermal, marine engine, and heat pump applications. The heat exchanger is formed by obtaining a tube of corrosion resistant metal, preferably titanium (25). The tube can be bent using a tube bender into a spiral, cork-screw helix with diameter of at least 19″ to accommodate most compressors if used within an air coil. The spacing between turns of the helix is about 2″. 254 SMO and other corrosion resistant alloys can be substituted for titanium, but titanium is the preferred alloy to prevent corrosion and prevent staining of water from copper and possibly killing marine life in aquarium use from the copper. The length of the tube is adjusted for the desired BTU output of energy and for the proper length needed for “phase change” to occur in its function as either evaporator or condenser specific for each application. Titanium tubes are available from mills and distributors throughout the U.S. and abroad. The last 15 cm are left straight (not bent into a helix) on both ends. The spiral shape will make the final design work to increase the turbulence in a second tube, described below to further increase the heat transfer.

A second tube (26) is then slid over the internal tube. A clear, UV resistant, flexible PVC spa hose is prefered but any nylon or other composition tube can be used. A clear flexible PVC tube is preferred, with or without a supporting internal plastic helix, so that the internal tube is seen through the clear PVC. This is for future repair in order to visualize bubbling leak sites. This type of hose is readily available at industrial hose supply locations throughout the USA and worldwide. One source of spa hose is Industrial Hose and Supply, Pompano Beach, Fla.

PVC “Tees” (21) are glued using blue PVC cement to both ends of the hose. The top Tee (28) is faced upwards for forming a “Hartford” (PVC) loop in heat pump swimming pool heating/cooling applications and the bottom (29) is faced outward for attachment to the water inlet line. These can be built in any direction for specific industry use, though.

A ½″ Female Pipe Thread (FPT) bushing (23) is placed over both ends of the internal tube and cemented into the end of both the Tees. These are available at any home improvement or hardware store.

A ½″ Swedgelok™ or any other brand of “tank fitting” (24), also called a compression fitting, usually brass or stainless steel, is screwed tightly into both the bushings (23). These are available from any plumbing supply and the “bore through” variety is preferred. One Source is Collins-Olliver of Baton Rouge, La. Now the water chamber is sealed. Water is entered into the bottom (30) and out the top (22) and the gas or liquid medium inside the titanium tube (27) is sent the opposite direction (cross flow).

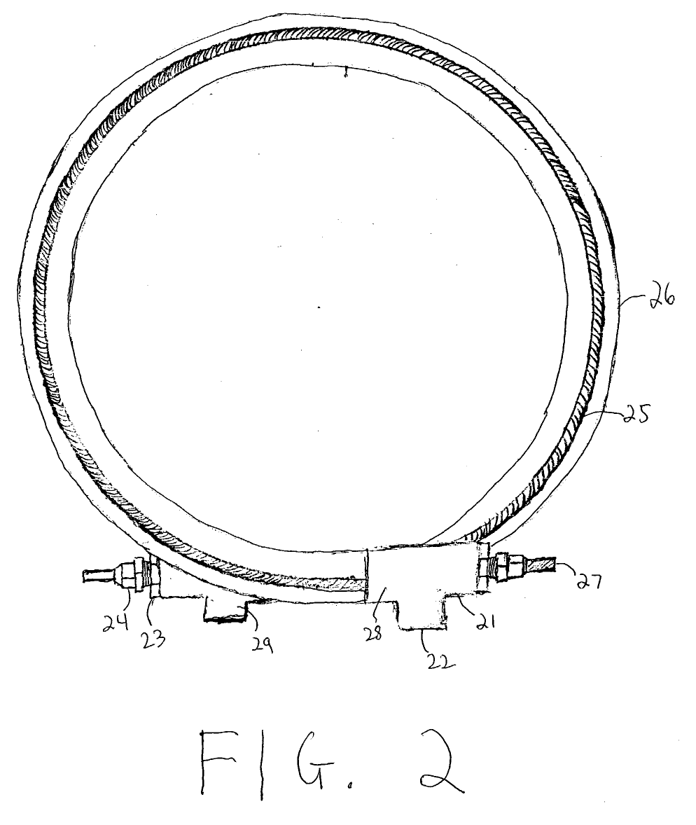

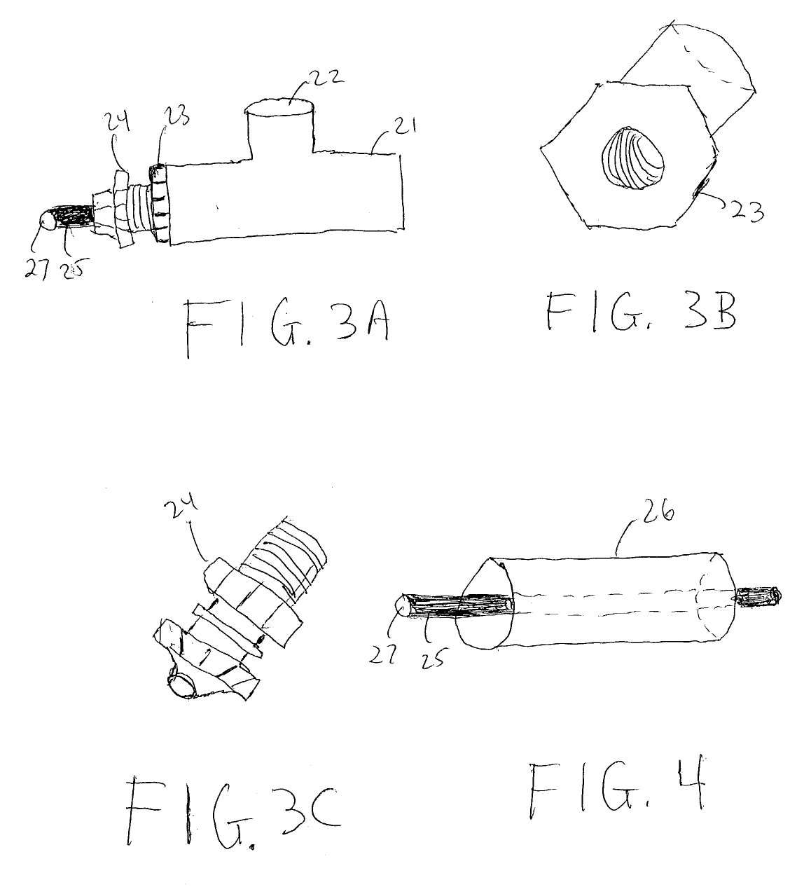

FIGS. 2, 3A-C, and 4—Additional Embodiments

Additional embodiments are shown in FIGS. 2, 3A, 3B, 3C, 4, 5A, and 5B. In FIG. 2 (top view), the straightened endings of the internal tube (27) are seen clearly. Each loop of the spa hose is lined exactly on top of the next loop and each loop is kept in place by a small bead of epoxy. The center space is left open so that the heat exchanger can be placed around a compressor.

FIG. 3A is the side view of the completed water sealing of each end of the hose. The water inlet/outlet is labeled (22) and the other parts are seen, specifically the bushing (23), pipe fitting (24), and the last portion of protruding titanium tube (25).

FIG. 3B is the bushing (23) and FIG. 3C is the pipe fitting (24).

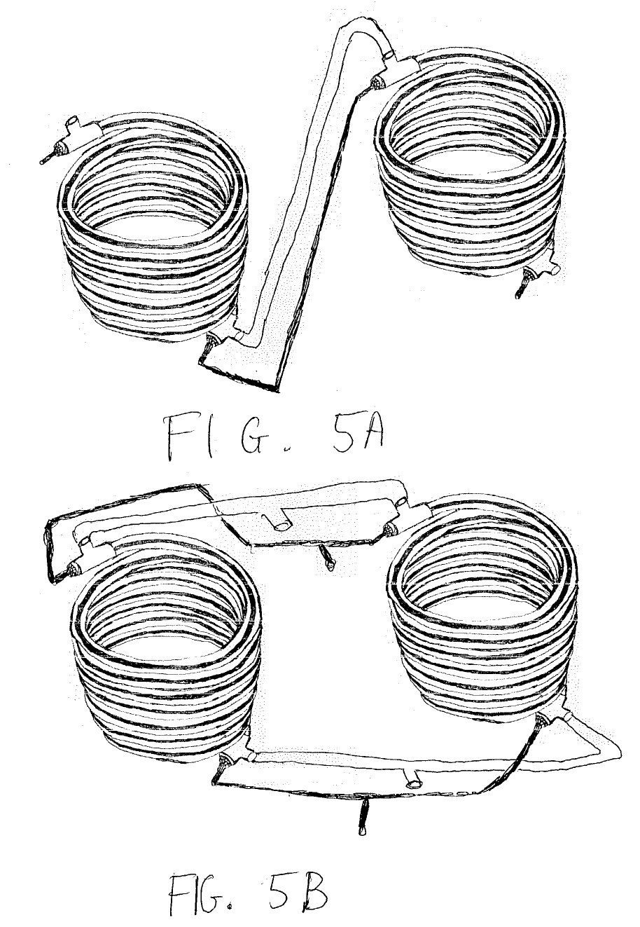

FIG. 4 is just a cutaway view showing the titanium tube (25) running through the spa hose (26).

FIG. 5A is a series connection and FIG. 5B is a parallel connection of 2 heat exchangers, showing that these can be plumbed in series and in parallel, with as many units of heat exchangers desired.

Conclusion, Ramifications, and Scope

Accordingly, the reader will see the heat exchanger is simple in design and thus easy to install or remove, easy to box and ship, and easy to assemble or disassemble for repair. The design of this heat exchanger, using titanium or SMO 254 or other corrosion resistant alloys, and using a flexible PVC hose, provides the following additional design benefits:

a) avoidance of corrosion and “pitting” through the tube from corrosive chemicals, including salt and bleach in the water, and

b) prevention of copper discoloration that harms plastered finishes on pools and spas, and

c) prevention of copper poisoning of marine life in aquariums and marine applications, and

d) prevention of “erosion” because, with the use of a plastic outer hose, metal cannot rub against itself as it does in many other designs, especially with metal stuffed in a tub.

Although the description above contains many specificities, these should not be construed as limiting the scope of the invention, but as merely providing illustrations of some of the presently preferred embodiments of this invention. For example, the heat exchanger can be used as a single unit or joined together with one or more in series or parallel arrangements, to provide the best performance for each application.

Thus the scope of the invention should be determined by the appended claims and their legal equivalents, rather than by the examples given.

1. A repairable heat exchanger device as a means for substantially transferring thermal energy between a medium inside an elongated tubular conduit to liquid surrounding said conduit and within another tube, comprising:
(a) a corrosion resistant elongated tubular conduit, and
(b) an outer tube that surrounds said conduit, and
(c) a sealing cap at each end comprising of the plurality of
i. a pvc tee, and
ii. a contiguous bushing, and
iii. a compression fitting screwed into said bushing sealing an outer fluid chamber.

2. The heat exchanger of claim 1 wherein said conduit is a metallic tube consisting of titanium.

3. The heat exchanger of claim 1 wherein said conduit and said outer tube are formed into a spiral helix so that said heat exchanger has a final shape of a helix.

4. The heat exchanger of claim 1 wherein said outer tube consists of flexible pvc.

5. The heat exchanger of claim 1 wherein said outer tube is ultra violet light resistant.

6. The heat exchanger of claim 1 wherein said conduit consists of SMO 254 stainless steel

7. The heat exchanger of claim 1 wherein said conduit is any corrosion resistant metal alloy.

8. The heat exchanger of claim 1 wherein said heat exchanger can exist as a single unit or as a combination of units joined by plumbing in series or in parallel.

9. The heat exchanger of claim 4 wherein said flexible pvc is clear enough to visualize the internal said conduit.

10. A method for substantially increasing the thermal conductance between one medium across said corrosion resistant elongated tubular conduit and another medium, said method including the steps of:
(a) shaping both said conduit and an outer tube into the shape of a spiral helix in order to substantially increase the turbulence of said medium as it propels around the said conduit through the channel created between said conduit and said outer tube, and
(b) designing inlet ports of said heat exchanger to propel one medium perpendicular to the direction of an other medium in said turbulent channel, thereby substantially increasing thermal conductance across surface of said conduit.

11. The method according to claim 10 wherein said spirally coiled conduit consists of titanium.

12. The method according to claim 10 wherein said turbulent heat exchange channel has a helical pitch is essentially the same as said spirally coiled conduit as set by the resting of each coil of said outer tube contiguously.

13. The method according to claim 10 wherein said conduit consists of SMO 254 stainless steel.

14. A method for repair of a tube in tube heat exchanger, comprising the steps of
(a) increasing pressure within an internal tube using compressed gas and placing said internal tube under water to locate source of leak, and
(b) cutting away damage piece of said internal tube, and
(c) welding said internal tube pieces back together
(d) restoring original heat exchanger to original configuration, and
(e) retesting said original heat exchanger to verify repair or need to repeat said repair steps for a newly discovered leak.

15. The method according to claim 14 wherein said internal tube consists of titanium

16. The method according to claim 14 wherein said internal tube consists of SMO 254

17. The method according to claim 14 wherein external tube is made of flexible pvc.

18. The method according to claim 14 wherein said heat exchanger's external tube is clear enough to see through to visualize the internal tube so that said repair is accomplished with the following additional steps
(a) accomplishing step (a) of claim 14 with said heat exchanger intact, by connecting outer tube to water and pumping said water through the tube, and
(b) cutting a small piece of the outer tube away and then cutting away damaged tube as described in step (b) of claim 14.

19. The method according to claim 14 wherein said heat exchanger can be shipped in a box, repaired the same day as arrival, and reshipped to customer.

20. The method according to claim 14 wherein said heat exchanger is shaped as a spiral helix.
